(19) United States
(12) Patent Application Publication
(10) Pub. No.: US 2012/0088828 A1
(43) Pub. Date: Apr. 12, 2012

(54) HIGH SURFACE ACTIVITY PESTICIDES

(75) Inventors: Victor F. Man, St. Paul, MN (US); Yvonne M. Killeen, South St. Paul, MN (US); Michael C. DeNoma, Vadnais Heights, MN (US); Susan M. Viall, Rosemount, MN (US); Kelly J. Herrera, Eagan, MN (US); S. John Barcay, Burnsville, MN (US)

(73) Assignee: ECOLAB USA INC., St. Paul, MN (US)

(21) Appl. No.: 13/272,039

(22) Filed: Oct. 12, 2011

Related U.S. Application Data
(60) Provisional application No. 61/392,362, filed on Oct. 12, 2010.

(51) Int. Cl. A01N 41/04; A01P 7/04; A01N 31/14

(52) U.S. Cl. 514/517; 514/723

(57) ABSTRACT

The present disclosure relates generally to the field of pesticides. In particular, the present disclosure relates to pesticide compositions that include high surface activity and slower drying surfactant pesticides.

### CROSS-REFERENCE TO RELATED APPLICATIONS

This application claims priority to Provisional Application Ser. No. 61/392,362 filed Oct. 12, 2010, which is incorporated by reference herein in its entirety.

### FIELD

The present disclosure relates generally to the field of pesticides. In particular, the present disclosure relates to pesticide compositions that include high surface activity and slower drying surfactant pesticides.

### BACKGROUND

Left unattended, pests such as insects and rodents can quickly infest enclosed structures, such as restaurants and homes. Examples of crawling pests which can infest areas in and around enclosed structures include cockroaches, ants, ground beetles and spiders. In addition to being a nuisance, some of these pests can also bring pathogens into the restaurant or home, creating unsanitary eating and living conditions.

The use of pesticide compositions has aided in decreasing the infestation of insects in and around residential and commercial structures. Various types of pesticide compositions and methods of repelling or terminating crawling pests are currently available, including gel baits, glue pads and poisons. Because the pests can enter walls through small cracks and crevices and inhabit relatively inaccessible areas, such as within floors and behind walls, various tools can be used to “flush” the pests from the wall. For example, flushing agents can be sprayed into the areas to irritate or agitate the pests and cause them to leave the inaccessible areas and come out into the open and expose themselves. Once the pests enter the open environment, they are exposed to a pesticide composition that terminates them.

In more recent years, attention has been directed to producing pesticides that are effective and ecologically friendly. In line with this trend, the Environmental Protection Agency (EPA) has issued a list of minimum risk pesticides §25(b) of the Federal Insecticide, Fungicide, and Rodenticide Act (FIFRA) that are not subject to federal registration requirements because their active and inert ingredients are demonstratably safe for their intended use. There is an ongoing need to provide effective pesticides which have reduced environmental impact.

### SUMMARY

Surprisingly, it has been found that high surface activity and slower drying surfactant pesticides are especially effective pesticides.

Accordingly, in an embodiment, the present disclosure relates to a method of killing pests using a pesticide composition that has a surfactant pesticide. In some embodiments, the surfactant pesticide is sodium lauryl sulfate. In some embodiments, the surfactant pesticide has a contact angle of about 23 degrees to about 45 degrees on PET film. In some embodiments, the pesticide composition also includes a co-surfactant. In some embodiments, the pesticide composition also includes additional functional ingredients.

In another embodiment, the present disclosure relates to a method of killing pests using a pesticide composition that has sodium lauryl sulfate and a co-surfactant.

### BRIEF DESCRIPTION OF THE DRAWINGS

FIG. 1 shows the results of a 48 Hour Mortality Test With a C₁₂ Alcohol Using Direct Spray.

FIG. 2 shows the results of a 48 Hour Mortality Test With a C₁₀ Alcohol Using Direct Spray.

FIG. 3 shows the results of a 48 Hour Mortality Test With a C₁₂ Alcohol Using a Pre-Treated Panel.

FIG. 4 shows the results of a 48 Hour Mortality Test With a C₁₀ Alcohol Using a Pre-Treated Panel.

FIG. 5 shows the results of contact angle measurements on PET slides.

FIG. 6 shows the effect of 5% propylene glycol on the drying time of a sodium lauryl sulfate solution.

FIG. 7 shows the effect of 10% propylene glycol on the drying time of a sodium lauryl sulfate solution.

FIG. 8 shows the results of 0.03% C₁₀ alcohol on the drying time of a sodium lauryl sulfate solution.

FIG. 9 shows the results of 0.06% C₁₀ alcohol on the drying time of a sodium lauryl sulfate solution.

FIG. 10 shows the results of the contact angle test on PET slides.

### DETAILED DESCRIPTION

In some aspects, the present disclosure relates to pesticide compositions that include selected surfactant pesticides. The selected surfactant pesticides have been found to be especially effective due to their high surface activity (increased wetting) and slower drying properties. While not wanting to be bound by theory, it is believed that the surfactant pesticides of the present disclosure are especially good at wetting the hydrophobic exoskeleton of insects and in doing so, interfere with the insect's bodily functions in such a way that the insect dies.

In some aspects, the present disclosure relates to pesticide compositions that include selected surfactant pesticides and an optional long-chain alcohol. Again, while not wanting to be bound by theory, it is believed that the addition of the long-chain alcohol improves the packing of the surfactant molecule by filling in the spaces between the surfactants as the surfactant solution wets the surface of an insect's exoskeleton. By filling in the spaces in between the surfactant molecules, the long-chain alcohols can increase the surface activity of the surfactant solution, decrease the contact angle on the exoskeleton surface, and therefore improve the insecticidal properties of the surfactant pesticide.

### Compositions

The pesticide compositions include a surfactant pesticide, an optional long-chain alcohol, and other optional ingredients. The pesticide compositions may include concentrate compositions or may be diluted to form use compositions. In general, a concentrate refers to a composition that is intended to be diluted with water or other diluent to provide a use solution that contacts an object to provide the desired effect. The pesticide compositions that contact the pests or surrounding areas can be referred to as the use compositions. The use compositions can include additional functional ingredients. The use compositions can have a solids content that is sufficient to provide the desired level of efficacy while avoiding wasting the pesticide compositions. The solids concentration refers to the concentration of the non-water components in the use compositions.

Exemplary concentrations of materials in the pesticide compositions are provided below.

| | | | |
|---|---|---|---|
| Material | Wt. % | Wt. % | Wt. % |

Concentrate Compositions

| | | | |
|---|---|---|---|
| Surfactant Pesticide | | | |
| (solid) | 90-100 | 93-100 | 95-100 |
| (liquid) | 1-50 | 6-30 | 9-20 |
| Co-Surfactant | 0-20 | 0-10 | 0-5 |
| Water or Diluent | balance | balance | Balance |
| Additional Functional | 0-20 | 0-10 | 0-5 |
| Ingredients | | | |

Use Compositions

| | | | |
|---|---|---|---|
| Surfactant Pesticide | 0.1-10 | 0.5-6 | 1-4 |
| Co-Surfactant | 0-5 | 0-2 | 0-1.5 |
| Water or Diluent | balance | | |
| Additional Functional | 0-10 | 0-6 | 0-4 |
| Ingredients | | | |

Surfactant Pesticide. As used herein, the term “surfactant pesticide” refers to a pesticide which also has surfactant properties. That is, a surfactant pesticide refers to a chemical substance which has the ability to kill or control pests, e.g., insects, and also has the ability to reduce or lower the surface tension of a liquid with which the surfactant pesticide comes into contact with. Examples of surfactant pesticides include nonionic surfactants, semi-polar nonionic surfactants, anionic surfactants, cationic surfactants, amphoteric surfactants, zwitterionic surfactants, and combinations of these.

Nonionic Surfactants. Nonionic surfactants are generally characterized by the presence of an organic hydrophobic group and an organic hydrophilic group and are typically produced by the condensation of an organic aliphatic, alkyl aromatic or polyoxyalkylene hydrophobic compound with a hydrophilic alkaline oxide moiety which in common practice is ethylene oxide or a polyhydration product thereof, polyethylene glycol. Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a nonionic surface-active agent. The length of the hydrophilic polyoxyalkylene moiety which is condensed with any particular hydrophobic compound can be readily adjusted to yield a water dispersible or water soluble compound having the desired degree of balance between hydrophilic and hydrophobic properties. Exemplary nonionic surfactants include the following:
Block polyoxypropylene-polyoxyethylene polymeric compounds based upon propylene glycol, ethylene glycol, glycerol, trimethylolpropane, and ethylenediamine as the initiator reactive hydrogen compound such as: difunctional block copolymers (Pluronic® products—BASF Corp.); and tetra-functional block copolymers (Tetronic® products—BASF Corp.)
Condensation products of one mole of alkyl phenol wherein the alkyl chain, of straight chain or branched chain configuration, or of single or dual alkyl constituent, contains from about 8 to about 18 carbon atoms with from about 3 to about 50 moles of ethylene oxide. The alkyl group can, for example, be represented by diisobutylene, di-amyl, polymerized propylene, iso-octyl, nonyl, and di-nonyl. These surfactants can be polyethylene, polypropylene, and polybutylene oxide condensates of alkyl phenols. (Igepal®—Rhone-Poulenc and Triton®—Union Carbide)
Condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range. (Neodol®—Shell Chemical Co. and Alfonic®—Vista Chemical Co)
Condensation products of one mole of saturated or unsaturated, straight or branched chain carboxylic acid having from about 8 to about 18 carbon atoms with from about 6 to about 50 moles of ethylene oxide. The acid can be a mixture of acids in the above defined carbon atoms range or it can be an acid having a specific number of carbon atoms within the range. (Nopalcol®—Henkel Corporation and Lipopeg®—Lipo Chemicals, Inc.)
Alkanoic acid esters formed by reaction with glycerides, glycerin, and polyhydric (saccharide or sorbitan/sorbitol) alcohols. All of these ester moieties have one or more reactive hydrogen sites on their molecule which can undergo further acylation or ethylene oxide (alkoxide) addition to control the hydrophilicity of these substances.

Low Foaming Nonionic Surfactants
Reverse block copolymers which are block copolymers, essentially reversed, by adding ethylene oxide to ethylene glycol to provide a hydrophile of designated molecular weight; and, then adding propylene oxide to obtain hydrophobic blocks on the outside (ends) of the molecule. The hydrophobic portion of the molecule weighs from about 1,000 to about 3,100 with the central hydrophile including 10% by weight to about 80% by weight of the final molecule. Also included are difunctional reverse block copolymers (Pluronic® R—BASF Corp.) and tetra-functional reverse block copolymers (Tetronic® R—BASF Corp.)
Capped nonionic surfactants which are modified by “capping” or “end blocking” the terminal hydroxy group or groups (of multifunctional moieties) to reduce foaming by reaction with a small hydrophobic molecule such as propylene oxide, butylene oxide, benzyl chloride; and, short chain fatty acids, alcohols or alkyl halides containing from 1 to about 5 carbon atoms; and mixtures thereof. Also included are reactants such as thionyl chloride which convert terminal hydroxy groups to a chloride group. Such modifications to the terminal hydroxy group may lead to all-block, block-heteric, heteric-block or all-heteric nonionics.
The alkylphenoxypolyethoxyalkanols of U.S. Pat. No. 2,903,486 issued Sep. 8, 1959 to Brown et al. and represented by the formula

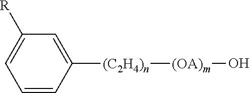

where
   R=an alkyl group of 8 to 9 carbon atoms;
   A=an alkylene chain of 3 to 4 carbon atoms;
   n=an integer of 7 to 16; and
   m=an integer of 1 to 10.
The polyalkylene glycol condensates of U.S. Pat. No. 3,048,548 issued Aug. 7, 1962 to Martin et al. having alternating hydrophilic oxyethylene chains and hydrophobic oxypropylene chains where the weight of the terminal hydrophobic chains, the weight of the middle hydrophobic unit and the weight of the linking hydrophilic units each represent about one-third of the condensate.
The defoaming nonionic surfactants disclosed in U.S. Pat. No. 3,382,178 issued May 7, 1968 to Lissant et al. having the general formula Z[(OR)ₙOH]_{z} where
   Z=an alkoxylatable material;
   R=a radical derived from an alkaline oxide which can be ethylene and propylene;
   n=an integer from 10 to 2,000 or more; and
   z=an integer determined by the number of reactive oxyalkylatable groups.
The conjugated polyoxyalkylene compounds described in U.S. Pat. No. 2,677,700, issued May 4, 1954 to Jackson et al. corresponding to the formula Y(C₃H₆O)ₙ(C₂H₄O)ₘH where
   Y=the residue of organic compound having from about 1 to 6 carbon atoms and one reactive hydrogen atom;
   n=an average value of at least about 6.4, as determined by hydroxyl number; and
   m=a value such that the oxyethylene portion constitutes about 10% to about 90% by weight of the molecule.
The conjugated polyoxyalkylene compounds described in U.S. Pat. No. 2,674,619, issued Apr. 6, 1954 to Lundsted et al. having the formula Y[(C₃H₆Oₙ(C₂H₄O)ₘH]ₓ where
   Y=the residue of an organic compound having from about 2 to 6 carbon atoms and containing x reactive hydrogen atoms where x has a value of at least about 2;
   n=a value such that the molecular weight of the polyoxypropylene hydrophobic base is at least about 900; and
   m=a value such that the oxyethylene content of the molecule is from about 10% to about 90% by weight.
Compounds falling within the scope of the definition for Y include, for example, propylene glycol, glycerine, pentaerythritol, trimethylolpropane, ethylenediamine and the like. The oxypropylene chains optionally, but advantageously, contain small amounts of ethylene oxide and the oxyethylene chains also optionally, but advantageously, contain small amounts of propylene oxide.
Additional conjugated polyoxyalkylene surface-active agents correspond to the formula: P[(C₃H₆O)ₙ(C₂H₄O)ₘH]ₓ where
   P=the residue of an organic compound having from about 8 to 18 carbon atoms and containing x reactive hydrogen atoms where x has a value of 1 or 2;
   n=a value such that the molecular weight of the polyoxyethylene portion is at least about 44; and
   m=a value such that the oxypropylene content of the molecule is from about 10% to about 90% by weight. In either case the oxypropylene chains may optionally contain small amounts of ethylene oxide and the oxyethylene chains may also optionally contain small amounts of propylene oxide.
Polyhydroxy fatty acid amide surfactants include those having the structural formula R²CONR¹Z where
   R¹═H, C₁-C₄ hydrocarbyl, 2-hydroxy ethyl, 2-hydroxy propyl, ethoxy, propoxy group, or a mixture thereof;
   R²=a C₅-C₃₁ hydrocarbyl, which can be straight-chain; and
   Z=a polyhydroxyhydrocarbyl having a linear hydrocarbyl chain with at least 3 hydroxyls directly connected to the chain, or an alkoxylated derivative (preferably ethoxylated or propoxylated) thereof. Z can be derived from a reducing sugar in a reductive amination reaction; such as a glycityl moiety.
The alkyl ethoxylate condensation products of aliphatic alcohols with from about 0 to about 25 moles of ethylene oxide. The alkyl chain of the aliphatic alcohol can either be straight or branched, primary or secondary, and generally contains from 6 to 22 carbon atoms.
The ethoxylated C₆-C₁₈ fatty alcohols and C₆-C₁₈ mixed ethoxylated and propoxylated fatty alcohols. Suitable ethoxylated fatty alcohols include the C₁₀-C₁₈ ethoxylated fatty alcohols with a degree of ethoxylation of from 3 to 50.
Nonionic alkylpolysaccharide surfactants include those disclosed in U.S. Pat. No. 4,565,647, Llenado, issued Jan. 21, 1986. These surfactants include a hydrophobic group containing from about 6 to about 30 carbon atoms and a polysaccharide, e.g., a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.
Fatty acid amide surfactants include those having the formula R⁶CON(R⁷)₂ where
   R⁶=an alkyl group containing from 7 to 21 carbon atoms; and each R⁷=independently hydrogen, C₁-C₄ alkyl, C₁-C₄ hydroxyalkyl, or —(C₂H₄O)ₓH, where x=from 1 to 3.
Another class of nonionic surfactants include the class defined as alkoxylated amines or, most particularly, alcohol alkoxylated/aminated/alkoxylated surfactants. These nonionic surfactants may be at least in part represented by the general formulae:

R²⁰—(PO)ₛN-(EO)ₜH,

R²⁰—(PO)ₛN-(EO)ₜH(EO)ₜH,

and

R²⁰—N(EO)ₜH; where
R²⁰=an alkyl, alkenyl or other aliphatic group, or an alkyl-aryl group of from 8 to 20, preferably 12 to 14 carbon atoms,
EO=oxyethylene,
PO=oxypropylene,
s=1-20, preferably 2-5,
t=1-10, preferably 2-5, and
u=1-10, preferably 2-5.
Other variations on the scope of these compounds may be represented by the alternative formula R²⁰—(PO)ᵥ—N[(EO)_{w}H][(EO)_{z}H], where
   R²⁰=an alkyl, alkenyl or other aliphatic group, or an alkyl-aryl group of from 8 to 20, preferably 12 to 14 carbon atoms,
   v=1 to 20 (e.g., 1, 2, 3, or 4 (preferably 2)), and
   w and z=independently 1-10, preferably 2-5.
These compounds are represented commercially by a line of products sold by Huntsman Chemicals as nonionic surfactants. A preferred chemical of this class includes Surfonic™ PEA 25 Amine Alkoxylate.

Semi-Polar Nonionic Surfactants
Amine oxides are tertiary amine oxides corresponding to the general formula:

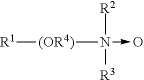

where the arrow=a conventional representation of a semi-polar bond; and,
R¹, R², and R³ may be aliphatic, aromatic, heterocyclic, alicyclic, or combinations thereof.

Generally, for amine oxides of detergent interest, R¹ is an alkyl radical of from about 8 to about 24 carbon atoms; R² and R³ are alkyl or hydroxyalkyl of 1-3 carbon atoms or a mixture thereof; R² and R³ can be attached to each other, e.g. through an oxygen or nitrogen atom, to form a ring structure; R⁴ is an alkaline or a hydroxyalkylene group containing 2 to 3 carbon atoms; and n ranges from 0 to about 20.

Useful water soluble amine oxide surfactants are selected from the coconut or tallow alkyl di-(lower alkyl) amine oxides, specific examples of which are dodecyldimethylamine oxide, tridecyldimethylamine oxide, tetradecyldimethylamine oxide, pentadecyldimethylamine oxide, hexadecyldimethylamine oxide, heptadecyldimethylamine oxide, octadecyldimethylamine oxide, dodecyldipropylamine oxide, tetradecyldipropylamine oxide, hexadecyldipropylamine oxide, tetradecyldibutylamine oxide, octadecyldibutylamine oxide, bis(2-hydroxyethyl)dodecylamine oxide, bis(2-hydroxyethyl)-3-dodecoxy-1-hydroxypropylamine oxide, dimethyl-(2-hydroxydodecyl)amine oxide, 3,6,9-trioctadecyldimethylamine oxide and 3-dodecoxy-2-hydroxypropyldi-(2-hydroxyethyl)amine oxide.
Semi-polar nonionic surfactants also include the water soluble phosphine oxides having the following structure:

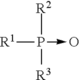

where the arrow=a conventional representation of a semi-polar bond;
R¹=an alkyl, alkenyl or hydroxyalkyl moiety ranging from 10 to about 24 carbon atoms in chain length; and
R² and R³ are each alkyl moieties separately selected from alkyl or hydroxyalkyl groups containing 1 to 3 carbon atoms.

Examples of useful phosphine oxides include dimethyldecylphosphine oxide, dimethyltetradecylphosphine oxide, methylethyltetradecylphosphone oxide, dimethylhexadecylphosphine oxide, diethyl-2-hydroxyoctyldecylphosphine oxide, bis(2-hydroxyethyl)dodecylphosphine oxide, and bis(hydroxymethyl)tetradecylphosphine oxide.
Semi-polar nonionic surfactants also include the water soluble sulfoxide compounds which have the structure:

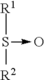

where the arrow=a conventional representation of a semi-polar bond;
R¹=an alkyl or hydroxyalkyl moiety of about 8 to about 28 carbon atoms, from 0 to about 5 ether linkages and from 0 to about 2 hydroxyl substituents; and
R²=an alkyl moiety consisting of alkyl and hydroxyalkyl groups having 1 to 3 carbon atoms.

Useful examples of these sulfoxides include dodecyl methyl sulfoxide; 3-hydroxy tridecyl methyl sulfoxide; 3-methoxy tridecyl methyl sulfoxide; and 3-hydroxy-4-dodecoxybutyl methyl sulfoxide.

Anionic Surfactants. Anionic surfactants includes those with a negative charge on the hydrophobic group or surfactants in which the hydrophobic section of the molecule carries no charge unless the pH is elevated to neutrality or above (e.g. carboxylic acids). Carboxylate, sulfonate, sulfate and phosphate are the polar (hydrophilic) solubilizing groups found in anionic surfactants. Of the cations (counter ions) associated with these polar groups, sodium, lithium and potassium impart water solubility; ammonium and substituted ammonium ions provide both water and oil solubility; and, calcium, barium, and magnesium promote oil solubility. The particular salts will be suitably selected depending upon the needs of the particular formulation.

Anionic surfactants are excellent detersive surfactants and have high foam profiles. Anionic surfactants are useful to impart special chemical or physical properties other than detergency within the composition. Anionics can be employed as gelling agents or as part of a gelling or thickening system. Anionics are also excellent solubilizers and can be used for hydrotropic effect and cloud point control.

The majority of large volume commercial anionic surfactants can be subdivided into five major chemical classes and additional sub-groups known to those of skill in the art and described in “Surfactant Encyclopedia,” Cosmetics & Toiletries, Vol. 104 (2) 71-86 (1989). The first class includes acylamino acids (and salts), such as acylgluamates, acyl peptides, sarcosinates (e.g. N-acyl sarcosinates), taurates (e.g. N-acyl taurates and fatty acid amides of methyl tauride), and the like. The second class includes carboxylic acids (and salts), such as alkanoic acids (and alkanoates), ester carboxylic acids (e.g. alkyl succinates), ether carboxylic acids, and the like. The third class includes phosphoric acid esters and their salts. The fourth class includes sulfonic acids (and salts), such as isethionates (e.g. acyl isethionates), alkylaryl sulfonates, alkyl sulfonates, sulfosuccinates (e.g. monoesters and diesters of sulfosuccinate), and the like. The fifth class includes sulfuric acid esters (and salts), such as alkyl ether sulfates, alkyl sulfates, and the like. Exemplary anionic surfactants include the following:
Linear and branched primary and secondary alkyl sulfates, alkyl ethoxysulfates, fatty oleyl glycerol sulfates, alkyl phenol ethylene oxide ether sulfates, the C₅-C₁₇ acyl-N—(C₁-C₄ alkyl) and —N—(C₁-C₂ hydroxyalkyl) glucamine sulfates, and sulfates of alkylpolysaccharides such as the sulfates of alkylpolyglucoside (the nonionic nonsulfated compounds being described herein).
Ammonium and substituted ammonium (such as mono-, di- and triethanolamine) and alkali metal (such as sodium, lithium and potassium) salts of the alkyl mononuclear aromatic sulfonates such as the alkyl benzene sulfonates containing from 5 to 18 carbon atoms in the alkyl group in a straight or branched chain, e.g., the salts of alkyl benzene sulfonates or of alkyl toluene, xylene, cumene and phenol sulfonates; alkyl naphthalene sulfonate, diamyl naphthalene sulfonate, and dinonyl naphthalene sulfonate and alkoxylated derivatives.
Anionic carboxylate surfactants such as alkyl ethoxy carboxylates, the alkyl polyethoxy polycarboxylate surfactants and the soaps (e.g. alkyl carboxyls). Secondary soap surfactants (e.g. alkyl carboxyl surfactants) include those which contain a carboxyl unit connected to a secondary carbon. The secondary carbon can be in a ring structure, e.g. as in p-octyl benzoic acid, or as in alkyl-substituted cyclohexyl carboxylates. The secondary soap surfactants typically contain no ether linkages, no ester linkages and no hydroxyl groups. Further, they typically lack nitrogen atoms in the head-group (amphiphilic portion). Suitable secondary soap surfactants typically contain 11-13 total carbon atoms, although more carbons atoms (e.g., up to 16) can be present.
Other anionic surfactants include olefin sulfonates, such as long chain alkene sulfonates, long chain hydroxyalkane sulfonates or mixtures of alkenesulfonates and hydroxyalkane-sulfonates. Also included are the alkyl sulfates, alkyl poly(ethyleneoxy) ether sulfates and aromatic poly(ethyleneoxy) sulfates such as the sulfates or condensation products of ethylene oxide and nonyl phenol (usually having 1 to 6 oxyethylene groups per molecule). Resin acids and hydrogenated resin acids are also suitable, such as rosin, hydrogenated rosin, and resin acids and hydrogenated resin acids present in or derived from tallow oil.

Cationic Surfactants. Surfactants are classified as cationic if the charge on the hydrotrope portion of the molecule is positive or surfactants in which the hydrotrope carries no charge unless the pH is lowered close to neutrality or lower, but which are then cationic (e.g. alkyl amines). In theory, cationic surfactants may be synthesized from any combination of elements containing an “onium” structure RnX+Y− and could include compounds other than nitrogen (ammonium) such as phosphorus (phosphonium) and sulfur (sulfonium). In practice, the cationic surfactant field is dominated by nitrogen containing compounds, probably because synthetic routes to nitrogenous cationics are simple and straightforward and give high yields of product, which can make them less expensive.

Cationic surfactants preferably include, more preferably refer to, compounds containing at least one long carbon chain hydrophobic group and at least one positively charged nitrogen. The long carbon chain group may be attached directly to the nitrogen atom by simple substitution; or more preferably indirectly by a bridging functional group or groups in so-called interrupted alkylamines and amido amines. Such functional groups can make the molecule more hydrophilic or more water dispersible, more easily water solubilized by co-surfactant mixtures, or water soluble. For increased water solubility, additional primary, secondary or tertiary amino groups can be introduced or the amino nitrogen can be quaternized with low molecular weight alkyl groups. Further, the nitrogen can be a part of branched or straight chain moiety of varying degrees of unsaturation or of a saturated or unsaturated heterocyclic ring. In addition, cationic surfactants may contain complex linkages having more than one cationic nitrogen atom.

The surfactant compounds classified as amine oxides, amphoterics and zwitterions are themselves typically cationic in near neutral to acidic pH solutions and can overlap surfactant classifications. Polyoxyethylated cationic surfactants generally behave like nonionic surfactants in alkaline solution and like cationic surfactants in acidic solution.

The simplest cationic amines, amine salts and quaternary ammonium compounds can be schematically drawn thus:

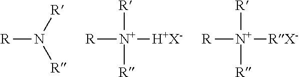

in which, R represents a long alkyl chain, R′, R″, and R′″ may be either long alkyl chains or smaller alkyl or aryl groups or hydrogen and X represents an anion.

The majority of large volume commercial cationic surfactants can be subdivided into four major classes and additional sub-groups known to those of skill in the art and described in “Surfactant Encyclopedia,” Cosmetics & Toiletries, Vol. 104 (2) 86-96 (1989). The first class includes alkylamines and their salts. The second class includes alkyl imidazolines. The third class includes ethoxylated amines. The fourth class includes quaternaries, such as alkylbenzyldimethylammonium salts, alkyl benzene salts, heterocyclic ammonium salts, tetra alkylammonium salts, and the like. Cationic surfactants are known to have a variety of properties including detergency in compositions of or below neutral pH, antimicrobial efficacy, thickening or gelling in cooperation with other agents, and the like.

Exemplary cationic surfactants include those having the formula R¹ₘ R²_{X}Y_{L}Z wherein each R¹ is an organic group containing a straight or branched alkyl or alkenyl group optionally substituted with up to three phenyl or hydroxy groups and optionally interrupted by up to four of the following structures:

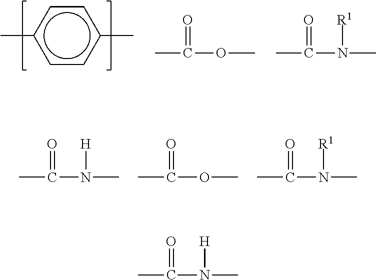

or an isomer or mixture of these structures, and which contains from 8 to 22 carbon atoms. The R′ groups can additionally contain up to 12 ethoxy groups. m is a number from 1 to 3. Preferably, no more than one R′ group in a molecule has 16 or more carbon atoms when m is 2, or more than 12 carbon atoms when m is 3. Each R² is an alkyl or hydroxyalkyl group containing from 1 to 4 carbon atoms or a benzyl group with no more than one R² in a molecule being benzyl, and x is a number from 0 to 11, preferably from 0 to 6. The remainder of any carbon atom positions on the Y group are filled by hydrogens.

Y can be a group including, but not limited to:

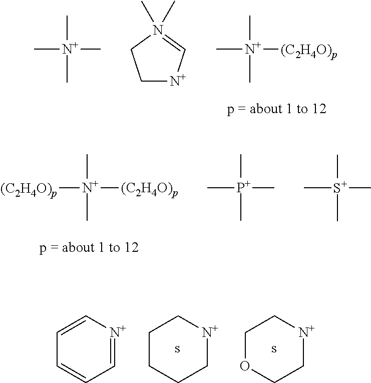

or a mixture thereof. Preferably, L is 1 or 2, with the Y groups being separated by a moiety selected from R¹ and R² analogs (preferably alkylene or alkenylene) having from 1 to 22 carbon atoms and two free carbon single bonds when L is 2. Z is a water soluble anion, such as sulfate, methylsulfate, hydroxide, or nitrate anion, particularly preferred being sulfate or methyl sulfate anions, in a number to give electrical neutrality of the cationic component.

Amphoteric Surfactants. Amphoteric or ampholytic surfactants contain both a basic and an acidic hydrophilic group and an organic hydrophobic group. These ionic entities may be any of the anionic or cationic groups described herein for other types of surfactants. A basic nitrogen and an acidic carboxylate group are the typical functional groups employed as the basic and acidic hydrophilic groups. In a few surfactants, sulfonate, sulfate, phosphonate or phosphate provide the negative charge.

Amphoteric surfactants can be broadly described as derivatives of aliphatic secondary and tertiary amines, in which the aliphatic radical may be straight chain or branched and wherein one of the aliphatic substituents contains from 8 to 18 carbon atoms and one contains an anionic water solubilizing group, e.g., carboxy, sulfo, sulfato, phosphato, or phosphono. Amphoteric surfactants are subdivided into two major classes known to those of skill in the art and described in “Surfactant Encyclopedia,” Cosmetics & Toiletries, Vol. 104 (2) 69-71 (1989). The first class includes acyl/dialkyl ethylenediamine derivatives (e.g. 2-alkyl hydroxyethyl imidazoline derivatives) and their salts. The second class includes N-alkylamino acids and their salts. Some amphoteric surfactants can be envisioned as fitting into both classes.

Amphoteric surfactants can be synthesized by methods known to those of skill in the art. For example, 2-alkyl hydroxyethyl imidazoline is synthesized by condensation and ring closure of a long chain carboxylic acid (or a derivative) with dialkyl ethylenediamine. Commercial amphoteric surfactants are derivatized by subsequent hydrolysis and ring-opening of the imidazoline ring by alkylation—for example with ethyl acetate. During alkylation, one or two carboxy-alkyl groups react to form a tertiary amine and an ether linkage with differing alkylating agents yielding different tertiary amines.

Long chain imidazole derivatives have the general formula:

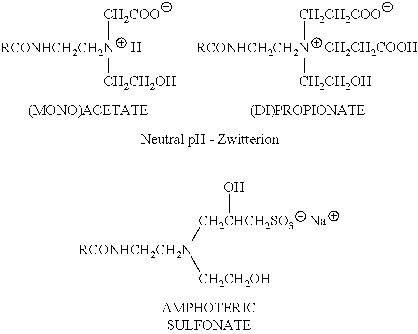

wherein R is an acyclic hydrophobic group containing from 8 to 18 carbon atoms and M is a cation to neutralize the charge of the anion, generally sodium. Exemplary commercially prominent imidazoline-derived amphoterics include: cocoamphopropionate, cocoamphocarboxy-propionate, cocoamphoglycinate, cocoamphocarboxy-glycinate, cocoamphopropyl-sulfonate, and cocoamphocarboxy-propionic acid. Preferred amphocarboxylic acids are produced from fatty imidazolines in which the dicarboxylic acid functionality of the amphodicarboxylic acid is diacetic acid and/or dipropionic acid.

The carboxymethylated compounds (glycinates) described herein above frequently are called betaines. Betaines are a special class of amphoteric discussed herein below in the section entitled, Zwitterion Surfactants.

Long chain N-alkylamino acids are readily prepared by reacting RNH₂, in which R═C₈-C₁₈ straight or branched chain alkyl, fatty amines with halogenated carboxylic acids. Alkylation of the primary amino groups of an amino acid leads to secondary and tertiary amines. Alkyl substituents may have additional amino groups that provide more than one reactive nitrogen center. Most commercial N-alkylamine acids are alkyl derivatives of beta-alanine or beta-N(2-carboxyethyl) alanine. Examples of commercial N-alkylamino acid ampholytes include alkyl beta-amino dipropionates, RN(C₂H₄COOM)₂ and RNHC₂H₄COOM. In these, R is preferably an acyclic hydrophobic group containing from 8 to 18 carbon atoms, and M is a cation to neutralize the charge of the anion.

Preferred amphoteric surfactants include those derived from coconut products such as coconut oil or coconut fatty acid. The more preferred of these coconut derived surfactants include as part of their structure an ethylenediamine moiety, an alkanolamide moiety, an amino acid moiety, preferably glycine, or a combination thereof; and an aliphatic substituent of from 8 to 18 (preferably 12) carbon atoms. Such a surfactant can also be considered an alkyl amphodicarboxylic acid. Disodium cocoampho dipropionate is one most preferred amphoteric surfactant and is commercially available under the tradename Miranol™ FBS from Rhodia Inc., Cranbury, N.J. Another most preferred coconut derived amphoteric surfactant with the chemical name disodium cocoampho diacetate is sold under the tradename Miranol™ C2M-SF Conc., also from Rhodia Inc., Cranbury, N.J.

Zwitterionic Surfactants. Zwitterionic surfactants can be thought of as a subset of the amphoteric surfactants. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion, a negative charged carboxyl group, and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxy, sulfonate, sulfate, phosphate, or phosphonate. Betaine and sultaine surfactants are exemplary zwitterionic surfactants.

A general formula for these compounds is:

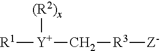

wherein R¹ contains an alkyl, alkenyl, or hydroxyalkyl radical of from 8 to 18 carbon atoms having from 0 to 10 ethylene oxide moieties and from 0 to 1 glyceryl moiety; Y is selected from the group consisting of nitrogen, phosphorus, and sulfur atoms; R² is an alkyl or monohydroxy alkyl group containing 1 to 3 carbon atoms; x is 1 when Y is a sulfur atom and 2 when Y is a nitrogen or phosphorus atom, R³ is an alkylene or hydroxy alkylene or hydroxy alkylene of from 1 to 4 carbon atoms and Z is a radical selected from the group consisting of carboxylate, sulfonate, sulfate, phosphonate, and phosphate groups.

Examples of zwitterionic surfactants having the structures listed above include: 4-[N,N-di(2-hydroxyethyl)-N-octadecylammonio]-butane-1-carboxylate; 5-[S-3-hydroxypropyl-S-hexadecylsulfonio]-3-hydroxypentane-1-sulfate; 3-[P,P-diethyl-P-3,6,9-trioxatetracosanephosphonio]-2-hydroxypropane-1-phosphate; 3-[N,N-dipropyl-N-3-dodecoxy-2-hydroxypropyl-ammonio]-propane-1-phosphonate; 3-(N,N-dimethyl-N-hexadecylammonio)-propane-1-sulfonate; 3-(N,N-dimethyl-N-hexadecylammonio)-2-hydroxy-propane-1-sulfonate; 4-[N,N-di(2(2-hydroxyethyl)-N(2-hydroxydodecyl)ammonio]-butane-1-carboxylate; 3-[S-ethyl-S-(3-dodecoxy-2-hydroxypropyl)sulfonio]-propane-1-phosphate; 3-[P,P-dimethyl-P-dodecylphosphonio]-propane-1-phosphonate; and S[N,N-di(3-hydroxypropyl)-N-hexadecylammonio]-2-hydroxy-pentane-1-sulfate. The alkyl groups can be straight or branched and saturated or unsaturated.

The zwitterionic surfactants include betaines of the general structure:

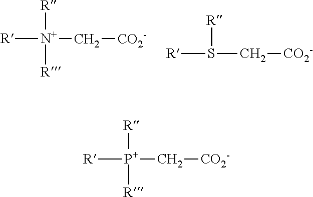

These surfactant betaines typically do not exhibit strong cationic or anionic characters at pH extremes nor do they show reduced water solubility in their isoelectric range.

Unlike “external” quaternary ammonium salts, betaines are compatible with anionics. Examples of suitable betaines include coconut acylamidopropyldimethyl betaine; hexadecyl dimethyl betaine; C₁₂₋₁₄ acylamidopropylbetaine; C₈₋₁₄ acylamidohexyldiethyl betaine; 4-C₁₄₋₁₆ acylmethylamidodiethylammonio-1-carboxybutane; C₁₆₋₁₈ acylamidodimethylbetaine; C₁₂₋₁₆ acylamidopentanediethylbetaine; and C₁₂₋₁₆ acylmethylamidodimethylbetaine.

Sultaines include those compounds having the formula (R(R¹)₂N⁺R²SO³⁻, in which R is a C₆-C₁₈ hydrocarbyl group, each R¹ is typically independently C₁-C₃ alkyl, e.g. methyl, and R² is a C₁-C₆ hydrocarbyl group, e.g. a C₁-C₃ alkylene or hydroxyalkylene group.

In some preferred embodiments, linear surfactant pesticides are selected over highly branched surfactant pesticides. Again, while not wanting to be bound by theory, it is believed that by improving the packing of the surfactant molecules, the contact angle is decreased, and the pesticidal properties of the surfactant pesticide are improved. In some preferred embodiments, the contact angle of the composition on PET film is from about 23° to about 45°, or below about 45°, below about 40°, below about 35°, or below about 25°. In some preferred embodiments, the surfactant pesticide has a single, predominant, alkyl, hydrocarbon tail. In some preferred embodiments, the hydrocarbon tail of the surfactant pesticide has a carbon chain length from about 6 to 16, 8 to 14, or 10 to 12. In some preferred embodiments, the surfactant pesticide is a miscelle-forming surfactant.

Preferred surfactant pesticides include sodium lauryl sulfate, alcohol ethoxylates, fatty acids, propoxylated quaternary ammonium compounds, or surfactants with one head group and two tail groups such as dioctylsulfosuccinate.

Sodium lauryl sulfate is a surfactant pesticide that is highly soluble in water, e.g., 250 g/L at 20° C. The sodium lauryl sulfate may be used as a liquid or a solid. Examples of suitable solid forms of sodium lauryl sulfate include, but are not limited to, powder, pellet and block forms. An example of a particularly suitable pellet form of sodium lauryl sulfate is needle form sodium lauryl sulfate. An example of a suitable commercially available needle form sodium lauryl sulfate includes Stepanol DX®, CAS number 151-21-3, available from Stephan Company, Northfield, Ill. While both powder form and pellet form sodium lauryl sulfate may be used to form the pesticide composition of the present invention, pellet form sodium lauryl sulfate is generally easier to handle and does not become airborne as easily as other solid forms. While the liquid concentrate form of sodium lauryl sulfate may also be effective in eliminating pests, liquid concentrate sodium lauryl sulfate has a freezing point of about 53 degrees Fahrenheit, making liquid concentrate sodium lauryl sulfate difficult to use effectively in certain applications.

Because sodium lauryl sulfate is on the §25(b) exempt list of minimum risk pesticides published by the EPA in the FIFRA, pesticide compositions that include sodium lauryl sulfate as the surfactant pesticide are ecologically acceptable.

Co-Surfactant. The pesticide composition may optionally also include a co-surfactant to reduce the drying of the pesticide composition, and in particular the surfactant pesticide, and prolong the activity of the pesticide composition. When a co-surfactant is included, the co-surfactant can be present up to the point where the system becomes unstable due to the insolubility of the co-surfactant. In some exemplary embodiments, the co-surfactant can be present at a ratio of surfactant pesticide to co-surfactant of about 1:0.03, 1:0.5, 1:1, or 1:3. A person skilled in the art will appreciate that the ratios may be highly varied depending on the selection of the surfactant pesticide and the co-surfactant. The co-surfactant preferably has a carbon chain length that is not too short or too long. If the carbon chain is too short, the co-surfactant is very volatile and has a strong odor. If the carbon chain is too long, the co-surfactant may be a solid and hard to process. That said, some solid co-surfactants can be used but require additional processing. Examples of suitable co-surfactants include long chain alcohols, guerbet alcohols, amine oxides, surfactants with one head group and two tail groups such as dioctylsulfosuccinate, protonated fatty acids, Tegin ISO (glyceryl isostearate), and guerbet alcohol ethoxylates. The co-surfactant preferably has a hydrophobic tail with a carbon chain length from about 6 to 16, 8 to 14, and 10 to 12. In some embodiments the co-surfactant is selected so that the carbon chain length of the co-surfactant is somewhat similar to the carbon chain length of the hydrophobic tail of the surfactant pesticide. The co-surfactant can be straight-chained or branched. In some embodiments, the co-surfactant is straight-chained.

Solvent. Any solvent can be used for the balance of the compositions. Water is preferred because it is readily available and environmentally friendly.

Additional Functional Ingredients. In some embodiments, the pesticide composition may optionally include additional components or agents, such as additional functional materials. In other embodiments, the surfactant pesticide may provide a large amount, or even all of the total weight of the pesticide composition, for example, in embodiments having few or no additional functional materials.

The additional functional ingredients provide desired properties and functionalities to the pesticide composition. For the purpose of this application, the term “functional ingredients” includes a material that when dispersed or dissolved in a use or concentrate solution, such as an aqueous solution, or when included in granules of the present disclosure, provides a beneficial property in a particular use. Some particular examples of functional ingredients are discussed in more detail below, although the particular ingredients discussed are given by way of example only, and a broad variety of other functional ingredients may be used.

The pesticide composition of the present disclosure may include attractants such as cockroach pheromones (e.g., sex attractants, aggregation pheromones) or food-based attractants (e.g., methylcyclopentenalone, maltol, fenugreek and other flavorings). When an attractant is included in the pesticide composition, the attractant may constitute between about 0.1% and about 5% by weight of the pesticide composition. The pesticide composition may also optionally include humectants such as glycerol to slow evaporation and maintain wetness of the pesticide composition after application. When a humectant is included in the pesticide composition, the humectant may constitute between about 0.5% and about 10% by weight of the pesticide composition. The disclosed compositions can also include additional inert ingredients. In some embodiments, the compositions include only additional inert ingredients that can be included in reduced/minimum risk pesticide products exempted under Section 25(b) of the Federal Insecticide, Fungicide, and Rodenticide Act (“FIFRA”).

### Methods of Making and Using

The disclosed compositions can be in the form of a liquid or solid (including, but not limited to, emulsions, microemulsions, thickened gels, liquids, powder, granular, extruded, or cast solids).

The pesticide compositions include those that kill or control a variety of pests. Pests killed or controlled by the pesticides and methods of the present invention include, but are not limited to, arthropods, e.g., insects, arachnids, crustaceans, and others. Arthropods killed or controlled by the pesticides of the present invention include, but are not limited to, cockroaches, and any other crawling pests, for example, ants, ground beetles, spiders, bed bugs and the like, flying pests, and their larvae and eggs.

The pesticide compositions can be applied to the area to be treated in a variety of ways. In some embodiments, the granules are applied to the area using a drop type, rotary type, or hand held type applicator. In other embodiments, the pesticide composition granules can be dissolved in a carrier, e.g., water, at the location of use to provide a use solution. Once the pesticide composition has been thoroughly dispersed in the carrier to form a substantially homogeneous solution, the pesticide composition may be applied onto a surface as a spray or foam. The use solution is applied onto the surface for an amount of time sufficient to terminate the pests.

The pesticide compositions may be employed at any of a wide variety of locations in which it is desired to eliminate pest infestation. The pesticide compositions are effective in killing pests, including crawling and flying pests, and in particular cockroaches. In addition, the pesticide compositions are generally more ecologically sustainable than traditional pesticides, making it particularly useful where it is desired to use an environmentally friendly pesticide. Such applications include using the pesticide compositions in and around restaurants, stores, homes, or other generally enclosed structures in which humans and animals are present.

The pesticide compositions can be applied in and around areas such as apartment buildings, bakeries, beverage plants, bottling facilities, breweries, cafeterias, candy plants, canneries, cereal processing and manufacturing plants, cruise ships, dairy barns, poultry facilities, flour mills, food processing plants, frozen food plants, homes hospitals, hotels, houses, industrial buildings, kennels, kitchens, laboratories, manufacturing facilities, mausoleums, meat processing and packaging plants, meat and vegetable canneries, motels, nursing homes, office buildings, organic facilities, restaurants, schools, stores, supermarkets, warehouses and other public buildings and similar structures. In particular, the pesticide compositions can be applied to surfaces, such as floors, where pests may harbor, including cracks, crevices, niches, dark areas, drains, and other harborage sites.

The pesticide compositions can also be used in methods for controlling insects, arachnids, and mites. The method includes allowing an effective amount of the pesticide compositions to act on the insects, arachnids, and/or mites.

### Packaging

The pesticide compositions may be packaged by any conventional means known in the art. For example, solid forms of the surfactant pesticide and any other ingredients may be premixed and packaged as a concentrate. Alternatively, the pesticide composition may be packaged in a water-soluble sachet for easy disposal after use and reduced packaging waste.

The present disclosure may be better understood with reference to the following examples. These examples are intended to be representative of specific embodiments of the disclosure, and are not intended as limiting the scope of the disclosure.

### EXAMPLES

### Example 1

### Effect of Long Chain Alcohols on the Insecticidal Properties of Sodium Lauryl Sulfate Solutions

This example determined the effect of long chain alcohols on the insecticidal properties of sodium lauryl sulfate (SLS) solutions. Four series of solutions were designed for testing:

(1) 1% SLS+(0-0.06%) C₁₂ alcohol
(2) 0.5% SLS+(0-0.03%) C₁₂ alcohol
(3) 1% SLS+(0-0.06% C₁₀ alcohol
(4) 0.5% SLS+(0-0.03%) C₁₀ alcohol
The complete formulations are shown in Table 1.

TABLE 1
Long Chain Alcohol and SLS Formulations

| | | EXP 1 | EXP 2 | EXP 3 | EXP 4 | EXP 5 | EXP 6 | EXP 7 | EXP 8 |
|---|---|---|---|---|---|---|---|---|---|
| SLS needles | 171048 | 1.0000 | 1.0000 | 1.0000 | 1.0000 | 0.5000 | 0.5000 | 0.5000 | 0.5000 |
| Lauryl alcohol, | | 0.0000 | 0.0200 | 0.0400 | 0.0600 | 0.0000 | 0.0100 | 0.0200 | 0.0300 |
| Sasol | | | | | | | | | |
| C10 alcohol | | | | | | | | | |
| DI water | | 99.0000 | 98.9800 | 98.9600 | 98.9400 | 99.5000 | 99.4900 | 99.4800 | 99.4700 |
| TOTAL | | 100.0000 | 100.0000 | 100.0000 | 100.0000 | 100.0000 | 100.0000 | 100.0000 | 100.0000 |
| pH | | 10.38 | 10.35 | 10.00 | 9.80 | 10.04 | 9.75 | 10.10 | 9.80 |
| | | EXP 9 | EXP 10 | EXP 11 | EXP 12 | EXP 13 | EXP 14 | EXP 15 | EXP 16 |
| SLS needles | 171048 | 1.0000 | 1.0000 | 1.0000 | 1.0000 | 0.5000 | 0.5000 | 0.5000 | 0.5000 |
| Lauryl alcohol, | | | | | | | | | |
| Sasol | | | | | | | | | |
| C10 alcohol | | 0.0000 | 0.0200 | 0.0400 | 0.0600 | 0.0000 | 0.0100 | 0.0200 | 0.0300 |
| DI water | | 99.0000 | 98.9800 | 98.9600 | 98.9400 | 99.5000 | 99.4900 | 99.4800 | 99.4700 |
| TOTAL | | 100.0000 | 100.0000 | 100.0000 | 100.0000 | 100.0000 | 100.0000 | 100.0000 | 100.0000 |
| | | same as #1 | | | | same as #5 | | | |
| | | not made | | | | not made | | | |
| pH | | | 9.98 | 10.04 | 10.07 | | 10.11 | 10.03 | 10.03 |

The concentration range of the added long chain alcohols was chosen because long chain alcohols are highly insoluble, they are “solubilized” by the SLS.

The solutions were applied either as a direct spray or as a pre-treatment. For the direct spray, 20 adult German cockroaches were selected and placed on a stainless steel panel. Pesticide was sprayed onto the cockroaches for 60 seconds. The cockroaches were placed in a jar with food and water. Mortality data was collected at 1, 2, 24, 48, and 72 hours after exposure to the spray. For the pre-treatment, 20 adult German cockroaches were selected and placed on a stainless steel panel that had been pre-treated with the pesticide. The cockroaches were placed on the panel for 60 seconds. The cockroaches were then placed in the jar with food and water. Mortality data was collected at 1, 2, 24, 48, and 72 hours after exposure to the pesticide on the panel.

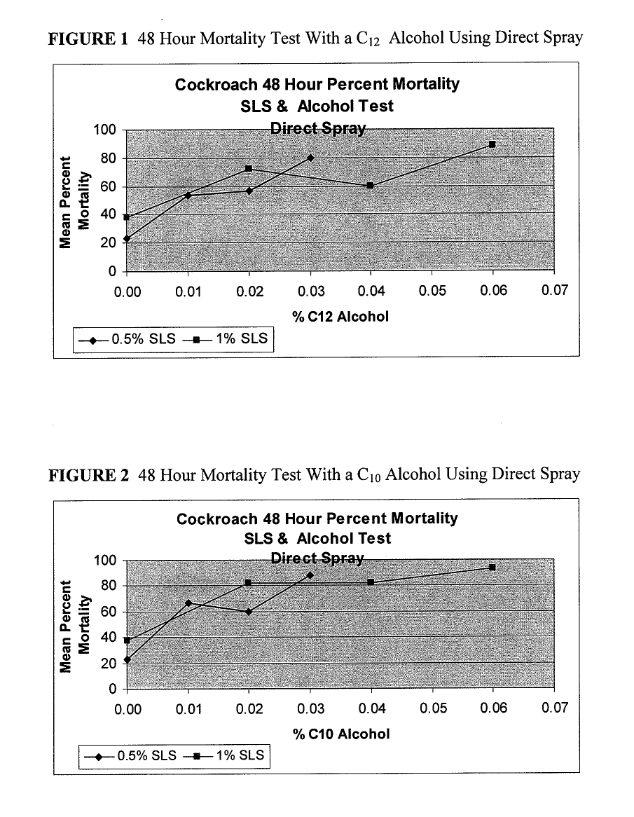

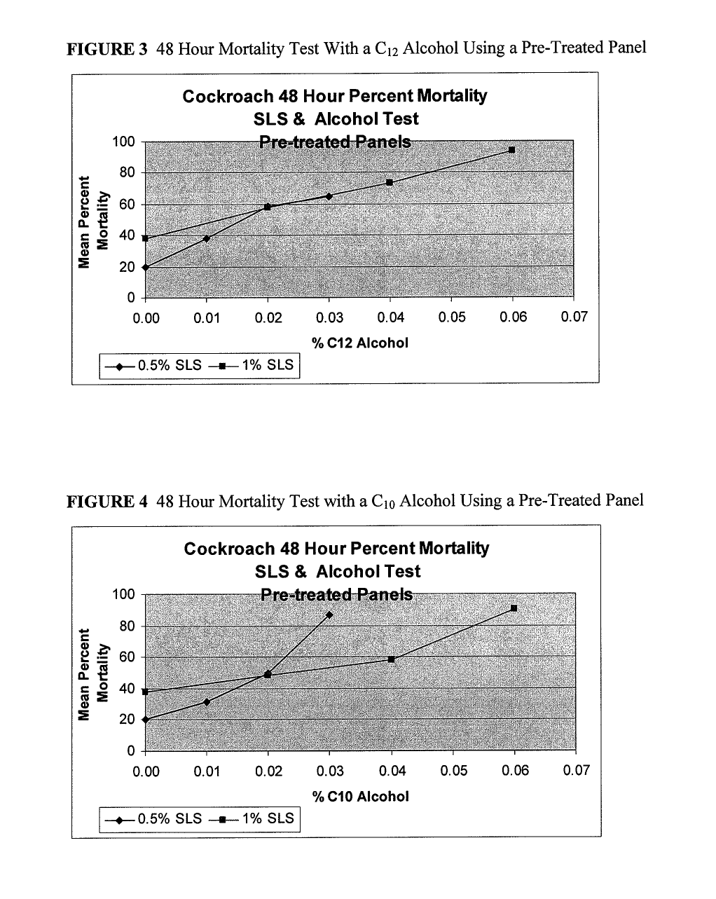

The mortality results are shown in FIG. 1 (48 Hour Mortality Test With a C₁₂ Alcohol Using Direct Spray), FIG. 2 (48 Hour Mortality Test With a C₁₀ Alcohol Using Direct Spray), FIG. 3 (48 Hour Mortality Test With a C₁₂ Alcohol Using a Pre-Treated Panel), and FIG. 4 (48 Hour Mortality Test with a C₁₀ Alcohol Using a Pre-Treated Panel).

FIGS. 1-4 clearly show that the addition of a long chain alcohol improves the efficacy of the SLS solution as an insecticide against cockroaches. FIGS. 1-4 also show an improvement in the efficacy of the SLS solution, regardless of whether the SLS concentration is 0.5% or 1.0%, which suggests even fewer chemicals can be used to treat cockroach infestations.

### Example 2

### Effect of Long Chain Alcohols on the Surface Activity of Sodium Lauryl Sulfate Solutions

This example determined the effect of long chain alcohols on the surface activity of sodium lauryl sulfate (SLS) solutions. For this example, polyethylene terephthalate (PET) slides were selected to simulate the hydrophobic exoskeleton of cockroaches. The wetting ability of the solutions was determined using a contact angle test.

The contact angle of these solutions was measured at room temperature on polyethylene terephthalate (PET) slides. After each of the compositions was prepared, the compositions were placed into an apparatus where a single drop of the composition was delivered to the PET slides. The deliverance of the drop to the substrate was recorded by a camera. The video captured by the camera was sent to a computer where the contact angle was determined.

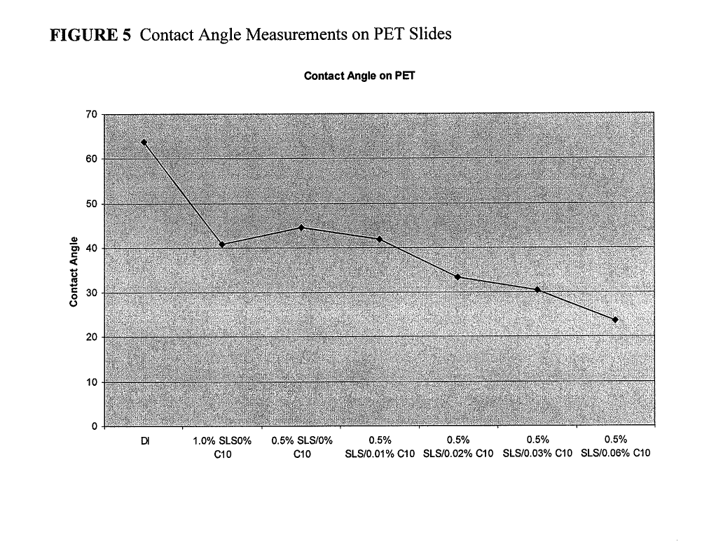

Deionized water was used as a control. Experimental formulas were made using 0.5% SLS, varying levels of a C₁₀ long chain alcohol, and the balance of water. The contact angle measurements and formulas are shown in Table 2. The results are also shown graphically in FIG. 5.

TABLE 2
Contact Angle Measurements on PET Slides

| | | Contact Angle | Average |
|---|---|---|---|
| | DI | 63.67 | |
| | | 63.91 | |
| | | 64.05 | 63.87667 |
| 1.0% SLS | 0% C10 | 41.21 | |
| | | 40.64 | |
| | | 40.81 | 40.8867 |
| 0.5% SLS | 0% C10 | 44.18 | |
| | | 44.4 | |
| | | 44.94 | 44.50667 |
| 0.5% SLS | 0.01% C10 | 41.35 | |
| | | 41.85 | |
| | | 42.2 | 41.8 |
| 0.5% SLS | 0.02% C10 | 32.65 | |
| | | 34.65 | |
| | | 32.45 | 33.25 |
| 0.5% SLS | 0.03% C10 | 31.17 | |
| | | 29.12 | |
| | | 30.92 | 30.40333 |
| 0.5% SLS | 0.06% C10 | 23.49 | |
| | | 24.41 | |
| | | 23.13 | 23.67667 |

Table 2 and FIG. 5 show that adding long chain alcohol into SLS solutions decreases the contact angle of the solution on PET slides. The water control did not wet PET surfaces well (contact angle=64 degrees). A 0.5% SLS solution (without alcohol) improved the contact angle to 45 degrees. And the addition of 0.06% C₁₀ alcohol decreased the contact angle to 24 degrees. The lower the contact angle, the better the wetting properties. Thus, the SLS solution with 0.06% C₁₀ alcohol has the best wetting properties.

### Example 3

### Effect of Long Chain Alcohols on the Drying Time of Sodium Lauryl Sulfate Solutions

This example determined the effect of long chain alcohols on the drying time of sodium lauryl sulfate (SLS) solutions. SLS solutions are believed to be efficacious when wet and when dried believed to lose the ability to kill cockroaches. To test this, propylene glycol (a humectant) was added to a 1% SLS solution. Then the propylene glycol/SLS solution was applied to 2×4 inch stainless steel (304) coupons. The coupons were observed visually and timed how long it took them to dry. The propylene glycol/SLS solution was either applied using a standard hand spray nozzle or using a foaming hand soap dispenser. A 1% SLS solution with deionized water was used as the control. For the 10% solution of propylene glycol/SLS, the solutions were applied to aluminum weigh boats. The boats were weighed and visually observed at 15 minute intervals to determine drying time.

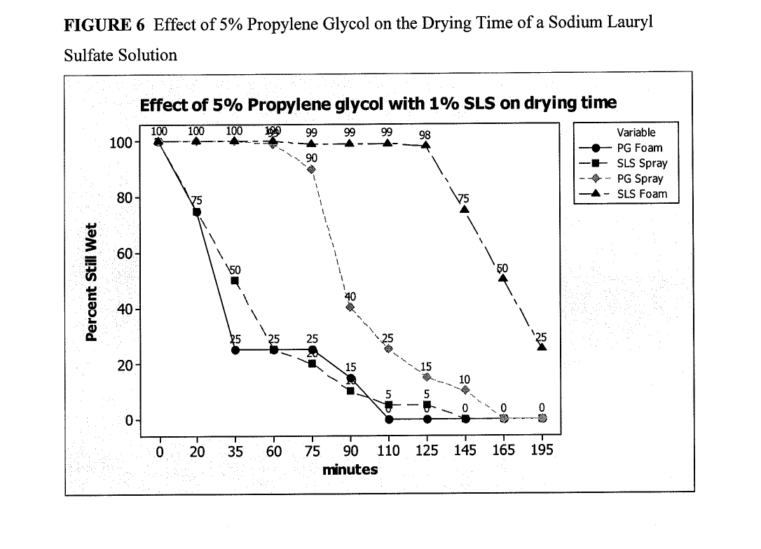

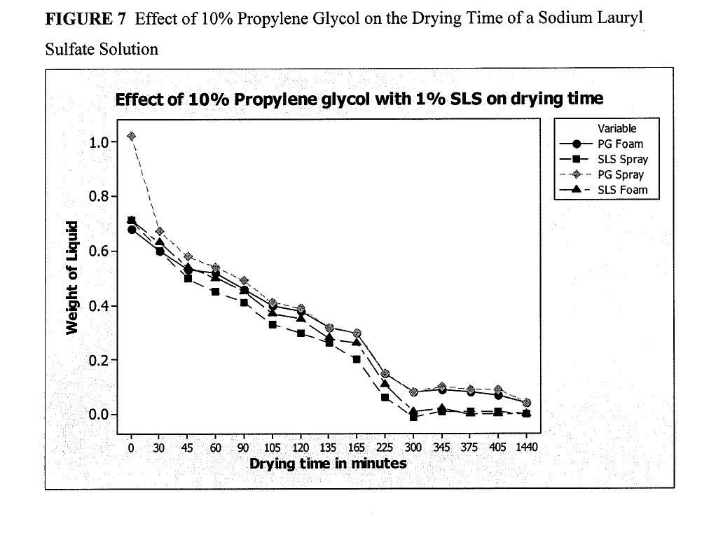

The results are shown below and demonstrate that adding 5% (Table 3 and FIG. 6) or 10% (Table 4 and FIG. 7) propylene glycol did not have a significant effect on the drying rate of the SLS solution.

TABLE 3
Effect of 5% Propylene Glycol on the Drying
Time of a Sodium Lauryl Sulfate Solution

| time | Percent Wet | Percent Wet | Percent Wet | Percent Wet |
|---|---|---|---|---|
| (min) | 5% PG | Control | 5% PG | Control |
| minutes | Foam | Spray | Spray | Foam |
| 0 | 100 | 100 | 100 | 100 |
| 20 | 75 | 75 | 100 | 100 |
| 35 | 25 | 50 | 100 | 100 |
| 60 | 25 | 25 | 99 | 100 |
| 75 | 25 | 20 | 90 | 99 |
| 90 | 15 | 10 | 40 | 99 |
| 110 | 0 | 5 | 25 | 99 |
| 125 | 0 | 5 | 15 | 98 |
| 145 | 0 | 0 | 10 | 75 |
| 165 | 0 | 0 | 0 | 50 |
| 195 | 0 | 0 | 0 | 25 |

TABLE 4
Effect of 10% Propylene Glycol on the Drying Time of a Sodium Lauryl
Sulfate Solution
Weight of liquid

| | | liquid wt (g) | liquid wt (g) | liquid wt (g) | liquid wt (g) |
|---|---|---|---|---|---|
| time | time | 10% PG | Control | 10% PG | Control |
| hours | minutes | Foam | Spray | Spray | Foam |
| 0.00 | 0 | 0.68 | 0.71 | 1.02 | 0.71 |
| 0.50 | 30 | 0.60 | 0.60 | 0.67 | 0.63 |
| 0.75 | 45 | 0.53 | 0.50 | 0.58 | 0.54 |
| 1.00 | 60 | 0.52 | 0.45 | 0.54 | 0.50 |
| 1.50 | 90 | 0.46 | 0.41 | 0.49 | 0.45 |
| 1.75 | 105 | 0.40 | 0.33 | 0.41 | 0.37 |
| 2.00 | 120 | 0.38 | 0.30 | 0.39 | 0.35 |
| 2.25 | 135 | 0.32 | 0.26 | 0.32 | 0.28 |
| 2.75 | 165 | 0.30 | 0.20 | 0.30 | 0.26 |
| 3.75 | 225 | 0.15 | 0.06 | 0.15 | 0.11 |
| 5.00 | 300 | 0.08 | −0.01 | 0.08 | 0.01 |
| 5.75 | 345 | 0.09 | 0.01 | 0.10 | 0.02 |
| 6.25 | 375 | 0.08 | 0.01 | 0.09 | 0.00 |
| 6.75 | 405 | 0.07 | 0.01 | 0.09 | 0.00 |
| 24.00 | 1440 | 0.04 | 0.00 | 0.04 | 0.00 |

The same experiment was completed using a C₁₀ long chain alcohol. For these experiments, the solutions were applied to aluminum weigh boats and the boats were weighed and visually observed at 15 minute intervals. A 0.5% SLS solution in deionized water was used as a control. The C₁₀/SLS formula had 0.5% SLS and 0.03% C₁₀ alcohol. The control was applied to the aluminum boats at 82° F. and the C₁₀/SLS formula was applied to the aluminum boats at 85° F.

TABLE 5
Effect of 0.03% C₁₀ Alcohol on the Drying
Time of a Sodium Lauryl Sulfate Solution

| | | liquid wt | liquid wt | liquid wt | liquid wt |
|---|---|---|---|---|---|
| | | (g) | (g) | (g) | (g) |
| time | time | C₁₀/SLS | Control | C₁₀/SLS | Control |
| hours | minutes | Foam | Spray | Spray | Foam |
| 0.00 | 0 | 0.35 | 0.28 | 0.30 | 0.23 |
| 0.25 | 15 | 0.35 | 0.26 | 0.28 | 0.23 |
| 0.50 | 30 | 0.29 | 0.21 | 0.22 | 0.18 |
| 0.75 | 45 | 0.27 | 0.17 | 0.18 | 0.15 |
| 1.00 | 60 | 0.22 | 0.13 | 0.14 | 0.10 |
| 1.25 | 75 | 0.20 | 0.09 | 0.11 | 0.08 |
| 1.50 | 90 | 0.17 | 0.07 | 0.08 | 0.05 |
| 1.75 | 105 | 0.16 | 0.05 | 0.05 | 0.03 |
| 2.00 | 120 | 0.13 | 0.03 | 0.04 | 0.02 |
| 2.25 | 135 | 0.10 | 0.01 | 0.01 | 0.01 |
| 6 days | 8640 | 0.00 | 0.00 | 0.00 | 0.00 |

| | | | | |
|---|---|---|---|---|
| Weight of weigh | 1.30 | 1.31 | 1.31 | 1.31 |
| boat | | | | |

The same experiment was completed, this time doubling the amount of C₁₀ alcohol to 0.06%.

TABLE 6
Effect of 0.06% C₁₀ Alcohol on the Drying
Time of a Sodium Lauryl Sulfate Solution

| | liquid wt (g) | liquid wt (g) | liquid wt (g) | liquid wt (g) |
|---|---|---|---|---|
| time | 0.06% C₁₀/ | 0.06% C₁₀/ | 0.03% C₁₀/ | 0.03% C₁₀/ |
| minutes | SLS spray | SLS foam | SLS spray | SLS foam |
| 0 | 0.32 | 0.41 | 0.28 | 0.23 |
| 15 | 0.26 | 0.38 | 0.26 | 0.23 |
| 30 | 0.22 | 0.35 | 0.21 | 0.18 |
| 45 | 0.16 | 0.31 | 0.17 | 0.15 |
| 60 | 0.12 | 0.31 | 0.13 | 0.1 |
| 75 | 0.10 | 0.25 | 0.09 | 0.08 |
| 105 | 0.04 | 0.21 | 0.05 | 0.03 |
| 120 | 0.02 | 0.16 | 0.03 | 0.02 |
| 135 | 0.02 | 0.14 | 0.01 | 0.01 |
| 150 | 0.01 | 0.12 | 0 | 0 |
| 165 | 0.01 | 0.10 | 0 | 0 |
| 180 | 0.01 | 0.08 | 0 | 0 |

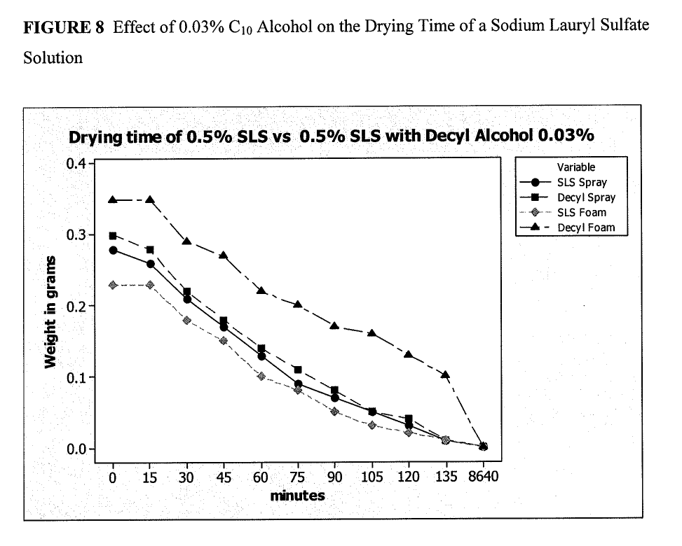

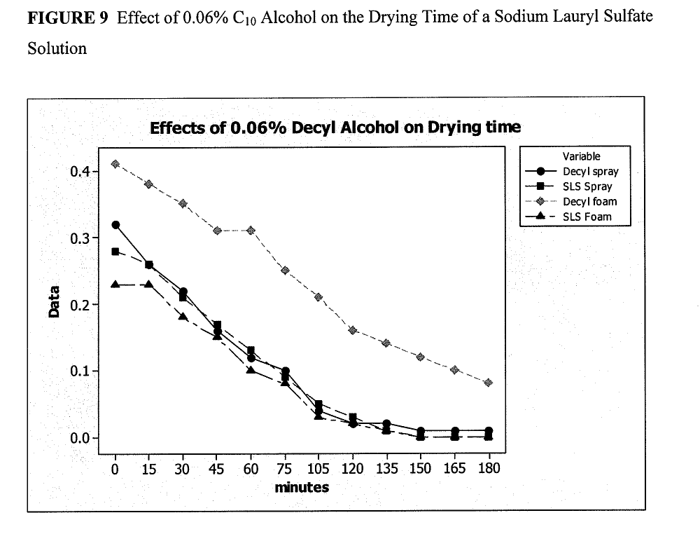

Table 5 and FIG. 8 and Table 6 and FIG. 9 show that even 0.03% decyl alcohol reduces the drying rate of 0.5% SLS, when applied as a foam. While not wishing to be bound by theory, it is believed that a slow drying time will allow the SLS to be efficacious for a long time.

### Example 4

### Effect of a Long Chain Alcohol on the Insecticidal Properties of an Alcohol ethoxylate

This example determined the effect of long chain alcohols on the insecticidal properties of alcohol ethoxylate solutions. For the test, five fully engorged female and five fully engorged male bed bugs were placed in jars. Egging sheets were placed in the jar. After eggs were deposited, the adult beg bugs were removed and the number of eggs counted. Pesticide solutions were prepared. The egging sheets were submerged into the pesticide solution for five minutes. After five minutes the egging sheets were removed and placed into a clean, dry container. The container was left open to allow the egging sheets to dry. Mortality should be recorded as % dead (unhatched) on day 16 post-ovoposition.

TABLE 7
Long Chain Alcohol and Alcohol Ethoxylate Formulations

| | | % Egg | % Total |
|---|---|---|---|
| | | Mortality | Mortality |
| #1 | 5% C10-12 alcohol ethoxylate 6 | 100 | 100 |
| | moleEO (Surfonic L12-6), 1% | | |
| | Fatty alcohol (Decyl alcohol) | | |
| #2 | 5% C10-12 alcohol ethoxylate 6 | 37.72 | 44.19 |
| | moleEO (Surfonic L12-6) | | |
| | Water | 15.69 | 15.69 |

Table 7 shows that 5% alcohol ethoxylate by itself (test #2) was more effective against bed bug eggs than water, but didn't eliminate 100% of the bed bug eggs. In contrast, test #1, a solution of 5% alcohol ethoxylate plus 1% of a C₁₀ alcohol, was 100% effective against bed bug eggs. The difference between test #1 and test #2 was that test #1 included the C₁₀ alcohol. This shows that the addition of the co-surfactant improved the insecticidal properties of the alcohol ethoxylate.

TABLE 8
Long Chain Alcohol and Alcohol Ethoxylate Formulations

| | | | % Egg | % Total |
|---|---|---|---|---|
| Formula | | | Mortality | Mortality |
| 1 | “High-High” | 5% C 10-12 | 100.00 | 100.00 |
| | ratio | alcohol | | |
| | | ethoxylate, 6 mole | | |
| | | EO (Surfonic L12- | | |
| | | 6) 1% Fatty | | |
| | | alcohol (Decyl | | |
| | | Alcohol) | | |
| 2 | “Low-High” | 1% C10-12 | 42.83 | 72.39 |
| | ratio | alcohol | | |
| | | ethoxylate, 6 mole | | |
| | | EO (Surfonic L12- | | |
| | | 6) | | |
| 3 | “Low-Low” | 1% C 10-12 | 8.38 | 32.60 |
| | ratio | alcohol | | |
| | | ethoxylate, 6 mole | | |
| | | E) (surfonic L12- | | |
| | | 6) 1% Fatty | | |
| | | alcohol (decyl | | |
| | | alcohol) | | |
| 4 | “High-Low” | 5% C10-12 | 78.57 | 78.57 |
| | ratio | alcohol | | |
| | | ethoxylate, 6 mole | | |
| | | EO (Surfonic L12- | | |
| | | 6) 0.40% Fatty | | |
| | | alcohol (Decyl | | |
| | | Alcohol) | | |
| Water | Water | Water | 14.68 | 16.13 |

Table 8 shows the insecticidal properties of various ratios of C₁₀ to C₁₂ alcohol ethoxylate to C₁₀ fatty alcohol. The solutions 1 and 4 with 5% of the alcohol ethoxylate (“high”) performed the best. When 1% of the C₁₀ alcohol was included, the composition has 100% efficacy against bed bug eggs. Even when only 0.4% of the C₁₀ alcohol was included, the composition still eliminated 78.57% of the bed bug eggs.

### Example 5

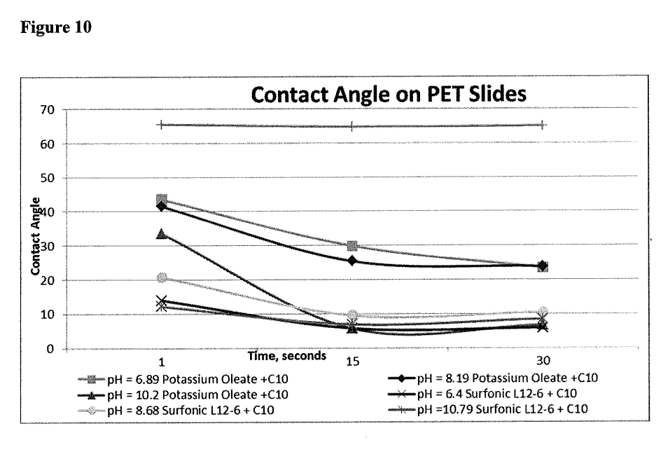

Example 5 measured the contact angle of various combinations of surfactant pesticide with a co-surfactant. The contact angle was measured using the test in Example 2. The results are shown in FIG. 10.

The above specification, examples and data provide a complete description of the manufacture and use of the disclosed compositions. Since many embodiments of the disclosure can be made without departing from the spirit and scope of the invention, the invention resides in the claims.

We claim:

1. A method of killing pests comprising: contacting the pest with a pesticide composition comprising a surfactant pesticide and a co-surfactant wherein the composition has a contact angle below about 45 degrees on PET film.

2. The method of claim 1, wherein the surfactant pesticide is selected from the group consisting of nonionic surfactants, semi-polar nonionic surfactants, anionic surfactants, cationic surfactants, amphoteric surfactants, zwitterionic surfactants, and mixtures thereof and the surfactant pesticide has at least one hydrophobic portion with about 6 to about 16 carbon atoms.

3. The method of claim 1, wherein the surfactant pesticide is selected from the group consisting of sodium lauryl sulfate, alcohol ethoxylates, quaternary ammonium compounds, fatty acids, fatty acid soaps, dioctylsulfosuccinate, and mixtures thereof.

4. The method of claim 1, wherein the co-surfactant is selected from the group consisting of long chain alcohols, amine oxides, guerbet alcohols, guerbet alcohol ethoxylates, protonated fatty acids, dioctylsulfosuccinate, surfactants with one hydrophilic head group and two hydrophobic tail groups, and mixtures thereof.

5. The method of claim 1, wherein the co-surfactant has a hydrophobic portion with a carbon chain length from about 6 to about 16.

6. The method of claim 1, wherein the pesticide composition includes additional functional ingredients.

7. The method of claim 1, wherein the contacting involves spraying the pest with the pesticide composition.

8. The method of claim 1, wherein the pest is selected from the group consisting of cockroaches, bed bugs, ants, flies, and termites.

9. The method of claim 1, wherein the surfactant pesticide has a contact angle on PET film of about 23 degrees to about 45 degrees.

10. A method of killing pests comprising: contacting the pest with a pesticide composition consisting of a surfactant pesticide having a hydrophobic group with about 6 to about 16 carbon atoms, a co-surfactant with a hydrophobic group with about 6 to about 16 carbon atoms, optional additional functional ingredients, and optional water, wherein the composition has a contact angle on PET film of about 23 degrees to about 45 degrees.
